(19) United States
(12) Patent Application Publication
(10) Pub. No.: US 2025/0221875 A1
(43) Pub. Date: Jul. 10, 2025

(54) WEARABLE DEVICE AND METHOD FOR CONTROLLING SAME DEVICE

(71) Applicant: SAMSUNG ELECTRONICS CO., LTD., Suwon-si, Gyeonggi-do (KR)

(72) Inventors: Kihun LEE, Suwon-si (KR); Kyuho LEE, Suwon-si (KR); Kyoungshin JIN, Suwon-si (KR)

(21) Appl. No.: 19/090,576

(22) Filed: Mar. 26, 2025

Related U.S. Application Data
(63) Continuation of application No. PCT/KR2023/016127, filed on Oct. 18, 2023.

(30) Foreign Application Priority Data
Nov. 10, 2022 (KR) 10-2022-0149897
Dec. 22, 2022 (KR) 10-2022-0182154

(51) Int. Cl. A61H 1/02

(52) U.S. Cl. CPC A61H 1/0244; A61H 2201/1207; A61H 2201/165; A61H 2201/5097

(57) ABSTRACT

A wearable device may generate a target magnetic field for receiving an identifier of an RFID tag included in a wearing portion of the wearable device by using an RFID reader included in the wearable device, determine whether the identifier is received from the RFID tag by using the RFID reader, and determine a worn state of the wearable device on the basis of whether the identifier is received.

### CROSS-REFERENCE TO RELATED APPLICATIONS

This application is a continuation application of International Application No. PCT/KR2023/016127 designating the United States, filed on Oct. 18, 2023, in the Korean Intellectual Property Receiving Office and claiming priority to Korean Patent Application No. 10-2022-0149897, filed on Nov. 10, 2022, and to Korean Patent Application No. 10-2022-0182154, filed on Dec. 22, 2022, in the Korean Intellectual Property Office, the disclosures of which are all hereby incorporated by reference herein in their entireties.

### BACKGROUND

### Field

Various example embodiments relate to technology for controlling a wearable device.

### Description of Related Art

A change into aging societies has contributed to a growing number of people who experience inconvenience and pain from reduced muscular strength or joint problems due to aging. Thus, there is a growing interest in walking assist devices, or other exercise devices, that enable elderly users or patients with reduced muscular strength or joint problems to walk and/or exercise with less effort.

### SUMMARY

According to an example embodiment, a method performed by a wearable device may include generating a target magnetic field to receive an identifier for a radio frequency identification (RFID) tag included in a wearing portion of the wearable device using an RFID reader included in the wearable device, determining whether the identifier is received from the RFID tag using the RFID reader, and determining a wearing state of the wearable device based on whether the identifier is received.

According to an embodiment, a wearable device may include at least one processor comprising processing circuitry, and memory comprising one or more storage media storing instructions that, when executed by the at least one processor individually or collectively, cause the wearable device to perform: generating a target magnetic field to receive an identifier for an RFID tag included in a wearing portion of the wearable device using an RFID reader included in the wearable device, determining whether the identifier is received from the RFID tag using the RFID reader, and determining a wearing state of the wearable device based on whether the identifier is received.

According to an embodiment, a wearable device may include at least one processor comprising processing circuitry, an RFID reader, a wearing portion including an RFID tag, a motor driver circuit controlled by the at least one processor, a motor electrically connected, directly or indirectly, to the motor driver circuit, and memory comprising one or more storage media storing instructions that, when executed by the at least one processor individually or collectively, cause the wearable device to perform: generating a target magnetic field to receive an identifier for the RFID tag using the RFID reader, determining whether the identifier is received from the RFID tag using the RFID reader, and determining a wearing state of the wearable device based on whether the identifier is received.

### BRIEF DESCRIPTION OF DRAWINGS

FIG. 1 is a diagram illustrating an overview of a wearable device worn on the body of a user, according to an example embodiment.

FIG. 2 is a diagram illustrating an exercise management system including a wearable device and an electronic device, according to an example embodiment.

FIG. 3 is a rear schematic view of a wearable device, according to an example embodiment.

FIG. 4 is a left side view of a wearable device, according to an example embodiment.

FIGS. 5A and 5B are diagrams illustrating a configuration of a control system of a wearable device, according to an example embodiment.

FIG. 6 is a diagram illustrating an interaction between a wearable device and an electronic device, according to an example embodiment.

FIG. 7 is a diagram illustrating a configuration of an electronic device, according to an example embodiment.

FIGS. 8 and 9 are diagrams illustrating a wearing detection system of a wearable device, according to an example embodiment.

FIG. 10 is a flowchart of a method of detecting the wearing of a wearable device, according to an example embodiment.

FIG. 11 is a diagram illustrating radio frequency identification (RFID) communication of a wearable device, according to an example embodiment.

FIG. 12 is a flowchart of a method of controlling an operation of a wearable device, according to an example embodiment.

FIG. 13 is a flowchart of a method of controlling an operation of a wearable device, according to an example embodiment.

FIG. 14 is a diagram illustrating a wearing portion of a wearable device, according to an example embodiment.

FIG. 15 is a diagram illustrating a configuration of a wearable device, according to an example embodiment.

### DETAILED DESCRIPTION

Hereinafter, various example embodiments will be described with reference to the accompanying drawings. However, this is not intended to limit the present disclosure to specific embodiments, and it should be understood that various modifications, equivalents, and/or alternatives of the embodiments of the present disclosure are included.

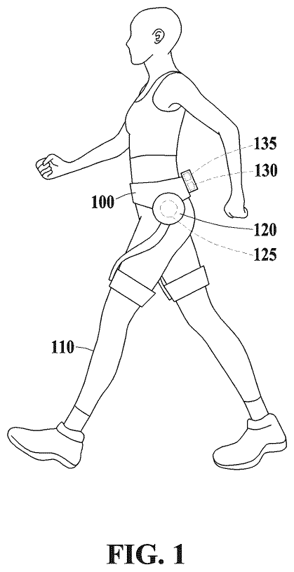

FIG. 1 is a diagram illustrating an overview of a wearable device worn on the body of a user, according to an embodiment.

Referring to FIG. 1, in an embodiment, a wearable device 100 may be a device worn on the body of a user 110 to assist the user 110 in walking, exercising, and/or working. In an embodiment, the wearable device 100 may be used to measure a physical ability (e.g., a walking ability, an exercise ability, or an exercise posture) of the user 110. In embodiments, the term “wearable device” may be replaced with a “wearable robot,” a “walking assist device,” or a “motion assistance device.” The user 110 may be a human or an animal but is not limited thereto. The wearable device 100 may be worn on the body (e.g., the lower body (the legs, ankles, knees, etc.), the upper body (the torso, arms, wrists, etc.), or the waist) of the user 110 to apply external force, such as assistance force and/or resistance force, to the body motion of the user 110. The assistance force may be force applied in the same direction as the body motion direction of the user 110, the force to assist the body motion of the user 110. The resistance force may be force applied in a direction that is opposite to the body motion direction of the user 110, the force hindering the body motion of the user 110. The term “resistance force” may also be referred to as an “exercise load.”

In an embodiment, the wearable device 100 may operate in a walking assistance mode to assist the user 110 in walking. In the walking assistance mode, the wearable device 100 may assist the user 110 in walking by applying the assistance force generated by a driving module 120 of the wearable device 100 to the body of the user 110. The wearable device 100 may allow the user 110 to walk independently or to walk for a long time by providing force required for walking of the user 110, to expand a walking ability of the user 110. The wearable device 100 may help in improving an abnormal walking habit or gait posture of a walker.

In an embodiment, the wearable device 100 may operate in an exercise assistance mode to enhance the exercise effect of the user 110. In the exercise assistance mode, the wearable device 100 may hinder the body motion of the user 110 or provide resistance to the body motion of the user 110 by applying the resistance force generated by the driving module 120 to the body of the user 110. When the wearable device 100 is a hip-type wearable device that is worn on the waist (or the pelvis) and the legs (e.g., the thighs) of the user 110, the wearable device 100 may provide an exercise load to the leg motion of the user 110 while being worn on the legs, thereby enhancing the exercise effect on the legs of the user 110. In an embodiment, the wearable device 100 may apply the assistance force to the body of the user 110 to assist the user 110 in exercising. For example, when a handicapped person or an elderly person wants to exercise wearing the wearable device 100, the wearable device 100 may provide the assistance force to assist the body motion during the exercise process. In an embodiment, the wearable device 100 may provide the assistance force and the resistance force in combination for each exercise section or time section, in such a manner of providing the assistance force in some exercise sections and the resistance force in other exercise sections.

In an embodiment, the wearable device 100 may operate in a physical ability measurement mode to measure a physical ability of the user 110. The wearable device 100 may measure motion information of the user using sensors (e.g., an angle sensor 125 and an inertial measurement unit (IMU) 135) provided in the wearable device 100 while the user is walking or exercising and may evaluate the physical ability of the user based on the measured motion information. For example, a gait index or an exercise ability indicator (e.g., muscular strength, endurance, balance, or exercise motion) of the user 110 may be estimated through the motion information of the user 110 measured by the wearable device 100. The physical ability measurement mode may include an exercise posture measurement mode to measure an exercise posture of the user.

In various embodiments of the present disclosure, for ease of description, the wearable device 100 is described as an example of a hip-type wearable device, as shown in FIG. 1, but the embodiments are not limited thereto. As described above, the wearable device 100 may be worn on another body part (e.g., the upper arms, lower arms, hands, calves, and feet) other than the waist and legs (particularly, the thighs), and the shape and configuration of the wearable device 100 may vary depending on the body part on which the wearable device 100 is worn.

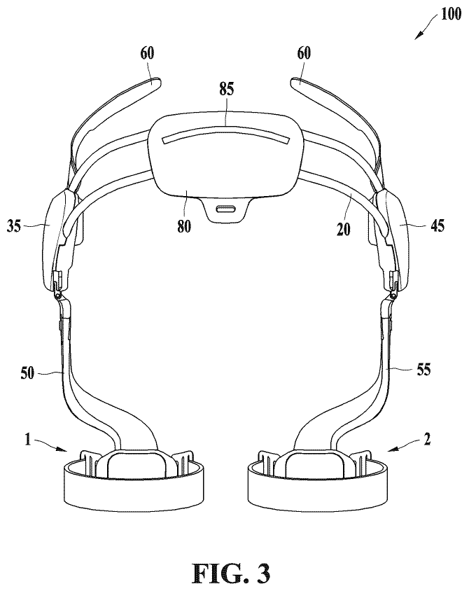

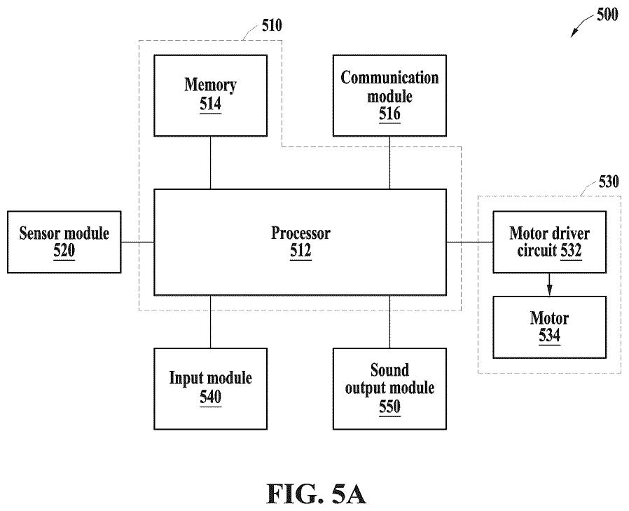

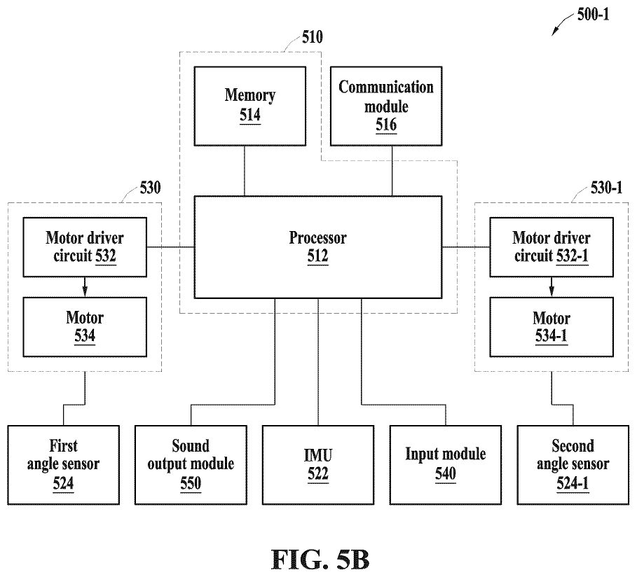

According to an embodiment, the wearable device 100 may include a support frame (e.g., leg support frames 50 and 55 and a waist support frame 20 of FIG. 3) configured to support the body of the user 110 when the wearable device 100 is worn on the body of the user 110, a sensor module (e.g., a sensor module 520 of FIG. 5A) configured to obtain sensor data including motion 30 information on the body motion (e.g., a motion of a leg, and a motion of the upper body) of the user 110, the driving module 120 (e.g., driving modules 35 and 45 of FIG. 3) configured to generate torque to be applied to the legs of the user 110, and a control module 130 (e.g., a control module 510 of FIGS. 5A and 5B, comprising processing circuitry) configured to control the wearable device 100.

The sensor module may include the angle sensor 125 and the IMU 135. The angle sensor 125 may measure a rotation angle of a leg support frame of the wearable device 100 corresponding to a hip joint angle value of the user 110. The rotation angle of the leg support frame measured by the angle sensor 125 may be estimated as a hip joint angle value (or a leg angle value) of the user 110. The angle sensor 125 may include, for example, an encoder and/or a Hall sensor. In an embodiment, the angle sensor 125 may be present near each of the right hip joint and the left hip joint of the user 110. The IMU 135 may include an acceleration sensor and/or an angular velocity sensor and may measure a change in acceleration and/or angular velocity according to a motion of the user 110. The IMU 135 may measure, for example, an upper body motion value of the user 110 corresponding to a motion value of a waist support frame (or a base body (a base body 80 of FIG. 3)) of the wearable device 100. A motion value of the waist support frame measured by the IMU 135 may be estimated as an upper body motion value of the user 110.

In an embodiment, the control module 130 and the IMU 135 may be arranged within the base body (e.g., the base body 80 of FIG. 3) of the wearable device 100. The base body may be disposed on a lumbar region (an area of the lower back) of the user 110 while the user 110 is wearing the wearable device 100. The base body may be formed or attached to an outer side of the waist support frame of the wearable device 100. The base body may be mounted on the lumbar region of the user 110 to provide a cushioning feeling to the lower back of the user 110 and may support the lower back of the user 110 together with the waist support frame.

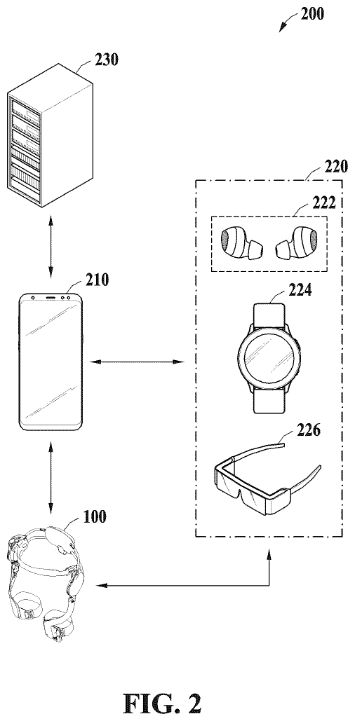

FIG. 2 is a diagram illustrating an exercise management system including a wearable device and an electronic device, according to an embodiment.

Referring to FIG. 2, an exercise management system 200 may include the wearable device 100 to be worn on the body of a user, an electronic device 210, another wearable device 220, and a server 230. In an embodiment, at least one (e.g., the other wearable device 220 or the server 230) of these devices may be omitted from the exercise management system 200, or one or more other devices (e.g., an exclusive controller device of the wearable device 100) may be added thereto.

In an embodiment, the wearable device 100 may be worn on the body of the user in the walking assistance mode to assist the motion of the user. For example, the wearable device 100 may be worn on the legs of the user to help the user in walking by generating the assistance force to assist the leg motion of the user.

In an embodiment, the wearable device 100 may generate the resistance force for hindering the body motion of the user or the assistance force for assisting the body motion of the user and apply the generated resistance force or assistance force to the body of the user to enhance the exercise effect of the user in the exercise assistance mode. In the exercise assistance mode, the user may select, through the electronic device 210, an exercise program (e.g., squat, split lunge, dumbbell squat, lunge and knee up, stretching, or the like) to use the wearable device 100 and/or exercise intensity to be applied to the wearable device 100. The wearable device 100 may control a driving module (comprising a motor and/or driving circuitry) of the wearable device 100 according to the exercise program selected by the user and obtain sensor data including motion information of the user through a sensor module. The wearable device 100 may adjust the strength of the resistance force or the assistance force applied to the user according to the exercise intensity selected by the user. For example, the wearable device 100 may control the driving module to generate the resistance force corresponding to the exercise intensity selected by the user.

In an embodiment, the wearable device 100 may be used to measure a physical ability of the user by interworking with the electronic device 210. The wearable device 100 may operate in the physical ability measurement mode, which is a mode to measure the physical ability of the user, under the control by the electronic device 210, and may transmit sensor data obtained by the motion of the user in the physical ability measurement mode to the electronic device 210. The electronic device 210 may estimate the physical ability of the user by analyzing the sensor data received from the wearable device 100.

The electronic device 210 may communicate with the wearable device 100 and may remotely control the wearable device 100 or provide the user with state information about a state (e.g., a booting state, a charging state, a sensing state, or an error state) of the wearable device 100. The electronic device 210 may receive sensor data obtained by a sensor in the wearable device 100 from the wearable device 100 and estimate the physical ability of the user or the exercise result based on the received sensor data. In an embodiment, when the user exercises wearing the wearable device 100, the wearable device 100 may obtain sensor data including motion information of the user using sensors and transmit the obtained sensor data to the electronic device 210. The electronic device 210 may extract a motion value of the user from the sensor data and evaluate an exercise posture of the user based on the extracted motion value. The electronic device 210 may provide the user with an exercise posture measured value and exercise posture evaluation information related to the exercise posture of the user through a graphical user interface (GUI).

In an embodiment, the electronic device 210 may execute a program (e.g., an application) configured to control the wearable device 100, and the user may adjust an operation or a set value of the wearable device 100 (e.g., the magnitude of torque output from a driving module (e.g., the driving modules 35 and 45 of FIG. 3), the volume of audio output from a sound output module (e.g., a sound output module 550 of FIGS. 5A and 5B), or the brightness of a lighting unit (e.g., a lighting unit 85 of FIG. 3)) through the corresponding program. The program executed by the electronic device 210 may provide a GUI for interaction with the user. The electronic device 210 may be a device in various forms. For example, the electronic device 210 may include, but is not limited to, a portable communication device (e.g., a smartphone), a computer device, an access point, a portable multimedia device, or a home appliance device (e.g., a television, an audio device, a projector device).

According to an embodiment, the electronic device 210 may be connected to the server 230 using short-range wireless communication or cellular communication. The server 230 may receive user profile information of the user who uses the wearable device 100 from the electronic device 210 and store and manage the received user profile information. The user profile information may include, for example, information about at least one of the name, age, gender, height, weight, or body mass index (BMI). The server 230 may receive exercise history information about an exercise performed by the user from the electronic device 210 and store and manage the received exercise history information. The server 230 may provide the electronic device 210 with various exercise programs or physical ability measurement programs that may be provided to the user.

According to an embodiment, the wearable device 100 and/or the electronic device 210 may be connected to the other wearable device 220. The other wearable device 220 may include, for example, wireless earphones 222, a smartwatch 224, or smart glasses 226, but is not limited thereto. In an embodiment, the smartwatch 224 may measure a biosignal including heart rate information of the user and transmit the measured biosignal to the electronic device 210 and/or the wearable device 100. The electronic device 210 may estimate the heart rate information (e.g., a current heart rate, a maximum heart rate, and an average heart rate) of the user based on the biosignal received from the smartwatch 224 and provide the estimated heart rate information to the user.

In an embodiment, the exercise result information, physical ability information, and/or exercise posture evaluation information evaluated by the electronic device 210 may be transmitted to the other wearable device 220 and provided to the user through the other wearable device 220. State information of the wearable device 100 may also be transmitted to the other wearable device 220 and provided to the user through the other wearable device 220. In an embodiment, the wearable device 100, the electronic device 210, and the other wearable device 220 may be connected to each other through wireless communication (e.g., Bluetooth communication or wireless-fidelity (Wi-Fi) communication).

In an embodiment, the wearable device 100 may provide (or output) feedback (e.g., visual feedback, auditory feedback, or haptic feedback) corresponding to a state of the wearable device 100 according to a control signal received from the electronic device 210. For example, the wearable device 100 may provide visual feedback through the lighting unit (e.g., the lighting unit 85 of FIG. 3) and provide auditory feedback through the sound output module (e.g., the sound output module 550 of FIGS. 5A and 5B). The wearable device 100 may include a haptic module and provide haptic feedback in the form of vibration to the body of the user through the haptic module. The electronic device 210 may also provide (or output) feedback (e.g., visual feedback, auditory feedback, or haptic feedback) corresponding to the state of the wearable device 100.

In an embodiment, the electronic device 210 may present a personalized exercise goal to the user in the exercise assistance mode. The personalized exercise goal may include respective target amounts of exercise for exercise types (e.g., strength exercise, balance exercise, and aerobic exercise) desired by the user, determined by the electronic device 210 and/or the server 230. When the server 230 determines a target amount of exercise, the server 230 may transmit information about the determined target amount of exercise to the electronic device 210. The electronic device 210 may personalize and present the target amounts of exercise for the exercise types, such as strength exercise, aerobic exercise, and balance exercise, according to a desired exercise program (e.g., squat, split lunge, or a lunge and knee up) and/or physical characteristics (e.g., the age, height, weight, and BMI) of the user. The electronic device 210 may display a GUI screen displaying the target amounts of exercise for the respective exercise types on a display.

In an embodiment, the electronic device 210 and/or the server 230 may include a database in which information about a plurality of exercise programs to be provided to the user through the wearable device 100 is stored. To achieve an exercise goal of the user, the electronic device 210 and/or the server 230 may recommend an exercise program that is suitable for the user. The exercise goal may include, for example, at least one of muscle strength improvement, physical strength improvement, cardiovascular endurance improvement, core stability improvement, flexibility improvement, or symmetry improvement. The electronic device 210 and/or the server 230 may store and manage the exercise program performed by the user, the results of performing the exercise program, and the like.

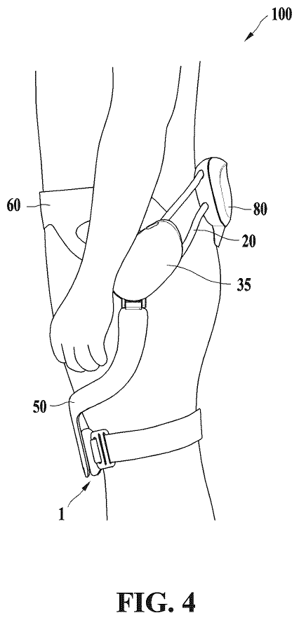

FIG. 3 is a rear schematic view of a wearable device, according to an embodiment. FIG. 4 is a left side view of a wearable device, according to an embodiment.

Referring to FIGS. 3 and 4, the wearable device 100 according to an embodiment may include the base body 80, the waist support frame 20, the driving modules 35 and 45, the leg support frames 50 and 55, thigh-fastening portions 1 and 2, and a waist-fastening portion 60. The base body 80 may include the lighting unit 85. In an embodiment, at least one (e.g., the lighting unit 85) of the above components may be omitted from the wearable device 100, or one or more other components (e.g., a haptic module) may be added thereto.

The base body 80 may be disposed on the lumbar region of a user while the user is wearing the wearable device 100. The base body 80 may be mounted on the lumbar region of the user to provide a cushioning feeling to the lower back of the user and may support the lower back of the user. The base body 80 may be hung on the hip region (an area of the hips) of the user to prevent or reduce a chance of the wearable device 100 from being separated downward due to gravity while the user is wearing the wearable device 100. The base body 80 may distribute a portion of the weight of the wearable device 100 to the lower back of the user while the user is wearing the wearable device 100. The base body 80 may be connected, directly or indirectly, to the waist support frame 20. Waist support frame connecting elements (not shown) to be connected, directly or indirectly, to the waist support frame 20 may be provided at both end portions of the base body 80.

In an embodiment, the lighting unit 85 may be arranged on an outer side of the base body 80. The lighting unit 85 may include a light source (e.g., a light-emitting diode (LED)). The lighting unit 85 may emit light under the control of a control module (not shown) (e.g., the control module 510 of FIGS. 5A and 5B). According to an embodiment, the control module may control the lighting unit 85 to provide (or output) visual feedback corresponding to the state of the wearable device 100 to the user through the lighting unit 85.

The waist support frame 20 may extend from both end portions of the base body 80. The lumbar region of the user may be accommodated inside the waist support frame 20. The waist support frame 20 may include at least one rigid body beam. Each beam may have a curved shape having a preset curvature to enclose the lumbar region of the user. The waist-fastening portion 60 may be connected, directly or indirectly, to an end portion of the waist support frame 20. The driving modules 35 and 45 may be connected, directly or indirectly, to the waist support frame 20.

In an embodiment, the control module, an IMU (not shown) (e.g., the IMU 135 of FIG. 1 or an IMU 522 of FIG. 5B), a communication module (not shown) (e.g., a communication module 516 of FIGS. 5A and 5B, comprising communication circuitry), and a battery (not shown) may be arranged inside the base body 80. The base body 80 may protect the control module, the IMU, the communication module, and the battery. The control module may generate a control signal for controlling an operation of the wearable device 100. The control module may include a control circuit including a processor configured to control actuators of the driving modules 35 and 45 and a memory. The control module may further include a power supply module (not shown) to supply power from a battery to each of the components of the wearable device 100.

In an embodiment, the wearable device 100 may include a sensor module (not shown) (e.g., the sensor module 520 of FIG. 5A) configured to obtain sensor data from one or more sensors. The sensor module may obtain sensor data that changes according to the motion of the user. In an embodiment, the sensor module may obtain sensor data including motion information of the user and/or motion information of the components of the wearable device 100. The sensor module may include, for example, an IMU (e.g., the IMU 135 of FIG. 1 or the IMU 522 of FIG. 5B) configured to measure an upper body motion value of the user or a motion value of the waist support frame 20, and an angle sensor (e.g., the angle sensor 125 of FIG. 1 or a first angle sensor 524 and a second angle sensor 524-1 of FIG. 5B) configured to measure a hip joint angle value of the user or a motion value of the leg support frames 50 and 55, but is not limited thereto. For example, the sensor module may further include at least one of a position sensor, a temperature sensor, a biosignal sensor, or a proximity sensor.

The waist-fastening portion 60 may be connected, directly or indirectly, to the waist support frame 20 to fasten the waist support frame 20 to the waist of the user. The waist-fastening portion 60 may include, for example, a pair of belts.

The driving modules 35 and 45 may generate external force (or torque) to be applied to the body of the user based on the control signal generated by the control module. For example, the driving modules 35 and 45 may generate assistance force or resistance force to be applied to the legs of the user. In an embodiment, the driving modules 35 and 45 may include a first driving module 45 disposed in a position corresponding to a position of the right hip joint of the user, and a second driving module 35 disposed in a position corresponding to a position of the left hip joint of the user. The first driving module 45 may include a first actuator and a first joint member, and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving electric power from the battery. When the motor is supplied with electric power and driven, the motor may generate force (assistance force) for assisting the body motion of the user or force (resistance force) for hindering the body motion of the user. In an embodiment, the control module may adjust the strength and direction of the force generated by the motor by adjusting the voltage and/or current supplied to the motor.

In an embodiment, the first joint member and the second joint member may receive power from the first actuator and the second actuator, respectively, and may apply external force to the body of the user based on the received power.

The first joint member and the second joint member may be arranged at positions corresponding to joint portions of the user, respectively. One side of the first joint member may be connected to the first actuator, and the other side of the first joint member may be connected to the first leg support frame 55. The first joint member may be rotated by the power received from the first actuator. An encoder or a Hall sensor that may operate as an angle sensor configured to measure a rotation angle of the first joint member (corresponding to the joint angle of the user) may be arranged on one side of the first joint member. One side of the second joint member may be connected to the second actuator, and the other side of the second joint member may be connected to the second leg support frame 50. The second joint member may be rotated by the power received from the second actuator. An encoder or a Hall sensor that may operate as an angle sensor configured to measure a rotation angle of the second joint member may be arranged on one side of the second joint member. “Connected” as used herein covers both direct and indirect connections.

In an embodiment, the first actuator may be arranged in a lateral direction of the first joint member, and the second actuator may be arranged in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, embodiments are not limited thereto, and an actuator and a joint member may share a rotation axis. In an embodiment, each actuator may be spaced apart from a corresponding joint member. In this case, the driving modules 35 and 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by a positional relationship between an actuator and a joint member and a power transmission structure described above.

In an embodiment, the leg support frames 50 and 55 may support the leg (e.g., the thigh) of the user when the wearable device 100 is worn on the leg of the user. For example, the leg support frames 50 and 55 may transmit power (torque) generated by the driving modules 35 and 45 to the thighs of the user, and the power may act as external force to be applied to the motion of the legs of the user. As one end portions of the leg support frames 50 and 55 are connected to the joint members to rotate and the other end portions of the leg support frames 50 and 55 are connected to the thigh-fastening portions 1 and 2, the leg support frames 50 and 55 may transmit the power generated by the driving modules 35 and 45 to the thighs of the user while supporting the thighs of the user. For example, the leg support frames 50 and 55 may push or pull the thighs of the user. The leg support frames 50 and 55 may extend in the longitudinal direction of the thighs of the user. The leg support frames 50 and 55 may be bent to surround at least a portion of the circumference of the thighs of the user. The leg support frames 50 and 55 may include the first leg support frame 55 configured to support the right leg of the user and the second leg support frame 50 configured to support the left leg of the user.

The thigh-fastening portions 1 and 2 may be connected to the leg support frames 50 and 55 and may fix the leg support frames 50 and 55 to the thighs. The thigh-fastening portions 1 and 2 may include a first thigh-fastening portion 2 configured to fasten the first leg support frame 55 to the right thigh of the user and a second thigh-fastening portion 1 configured to fasten the second leg support frame 50 to the left thigh of the user.

In an embodiment, the first thigh-fastening portion 2 may include a first cover, a first fastening frame, and a first strap, and the second thigh-fastening portion 1 may include a second cover, a second fastening frame, and a second strap. The first cover and the second cover may apply torques generated by the driving modules 35 and 45 to the thighs of the user. For example, the first cover and the second cover may be arranged on one side of the thighs of the user to push or pull the thighs of the user. The first cover and the second cover may be arranged on the front surfaces of the thighs of the user. The first cover and the second cover may be arranged in the circumferential directions of the thighs of the user. The first cover and the second cover may extend to both sides from the other end portions of the leg support frames 50 and 55 and may include curved surfaces corresponding to the thighs of the user. One of the ends of the first cover and the second cover may be connected to the fastening frames, and the other ends thereof may be connected to the straps.

The first fastening frame and the second fastening frame may be arranged, for example, to surround at least some portions of the circumferences of the thighs of the user, thereby preventing or reducing chances of the thighs of the user from being separated from the leg support frames 50 and 55. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIGS. 5A and 5B are diagrams illustrating a configuration of a control system of a wearable device, according to an embodiment.

Referring to FIG. 5A, the wearable device 100 may be controlled by a control system 500. The control system 500 may include a control module 510, a communication module 516, a sensor module 520, a driving module 530, an input module 540, and the sound output module 550. In an embodiment, at least one (e.g., the sound output module 550) of the above components may be omitted from the control system 500, or one or more other components (e.g., a haptic module) may be added thereto. Each driving module herein may comprise a motor and/or driving circuitry, for example as shown in FIG. 5A.

The driving module 530 may include a motor 534 to generate power (e.g., torque) and a motor driver circuit 532 to drive the motor 534. Although FIG. 5A illustrates the driving module 530 including one motor driver circuit 532 and one motor 534, the example of FIG. 5A is only an example. Referring to FIG. 5B, a control system 500-1 may include a plurality of (e.g., two or more) motor driver circuits 532 and 532-1 and a plurality of (e.g., two or more) motors 534 and 534-1. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 illustrated in FIG. 5B.

Referring back to FIG. 5A, the sensor module 520 may include a sensor circuit including at least one sensor. The sensor module 520 may obtain sensor data including motion information of a user or motion information of the wearable device 100. The sensor module 520 may transmit the obtained sensor data to the control module 510. The sensor module 520 may include an IMU 522 and an angle sensor (e.g., a first angle sensor 524 and a second angle sensor 524-1) as illustrated in FIG. 5B. The IMU 522 may measure an upper body motion value of the user. For example, the IMU 522 may sense X-axis, Y-axis, and Z-axis accelerations and X-axis, Y-axis, and Z-axis angular velocities according to the motion of the user. The IMU 522 may be used to measure, for example, at least one of a forward and backward tilt, a left and right tilt, or the rotation of the body of the user. In addition, the IMU 522 may obtain motion values (e.g., acceleration values and angular velocity values) of a waist support frame (e.g., the waist support frame 20 of FIG. 3) of the wearable device 100. The motion values of the waist support frame may correspond to upper body motion values of the user.

The angle sensor may measure a hip joint angle value according to the motion of the leg of the user. Sensor data that may be measured by the angle sensor may include, for example, a hip joint angle value of the right leg, a hip joint angle value of the left leg, and information on the motion direction of the leg. For example, the first angle sensor 524 of FIG. 5B may obtain the hip joint angle value of the right leg of the user, and the second angle sensor 524-1 may obtain the hip joint angle value of the left leg of the user. The first angle sensor 524 and the second angle sensor 524-1 may each include, for example, an encoder and/or a Hall sensor. Furthermore, the angle sensor may obtain motion values of the leg support frames of the wearable device. For example, the first angle sensor 524 may obtain a motion value of the first leg support frame 55, and the second angle sensor 524-1 may obtain a motion value of the second leg support frame 50. The motion values of the leg support frames may correspond to the hip joint angle values.

In an embodiment, the sensor module 520 may further include at least one of a position sensor configured to obtain a position value of the wearable device 100, a proximity sensor configured to sense the proximity of an object, a biosignal sensor configured to detect a biosignal of the user, or a temperature sensor configured to measure an ambient temperature.

The input module 540 may receive instructions or data to be used by another component (e.g., a processor 512) of the wearable device 100 from the outside (e.g., the user) of the wearable device 100. The input module 540 may include an input component circuit. The input module 540 may include, for example, a key (e.g., a button) or a touch screen. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The sound output module 550 may output a sound signal to the outside of the wearable device 100. The sound output module 550 may provide auditory feedback to the user. For example, the sound output module 550 may include a speaker configured to play back a guiding sound signal (e.g., an operation start sound, an operation error alarm, or an exercise start alarm), music content, or a guiding voice for auditorily informing predetermined information (e.g., exercise result information or exercise posture evaluation information).

In an embodiment, the control system 500 may further include a battery (not shown) configured to supply power to each component of the wearable device. The wearable device may convert the power of the battery into power that is suitable for operating voltage of each component of the wearable device and supply the converted power to each component.

The driving module 530 may generate external force to be applied to the leg of the user under the control of the control module 510. The driving module 530 may generate torque to be applied to the legs of the user based on a control signal generated by the control module 510. The control module 510 may transmit the control signal to the motor driver circuit 532. The motor driver circuit 532 may control an operation of the motor 534 by generating a current signal (or voltage signal) corresponding to the control signal and supplying the generated current signal (or voltage signal) to the motor 534. In some cases, the current signal may not be supplied to the motor 534. When the motor 534 is supplied with the current signal and driven, the motor 534 may generate torque for assistance force for assisting the leg motion of the user or resistance force for hindering the leg motion of the user.

The control module 510 may control the overall operation of the wearable device and may generate a control signal for controlling each component (e.g., the communication module 516 or the driving module 530). The control module 510 may include a processor 512 and a memory 514.

The processor 512 may execute, for example, software to control at least one other component (e.g., a hardware or software component) of the wearable device connected to the processor 512 and may perform various types of data processing or computation. The software may include an application for providing a GUI. According to an embodiment, as at least a part of data processing or computation, the processor 512 may store instructions or data received from another component (e.g., the communication module 516) in the memory 514, process the instructions or data stored in the memory 514, and store result data in the memory 514. According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from or in conjunction with the main processor. The auxiliary processor may be implemented separately from the main processor or as part of the main processor.

The memory 514 may store a variety of data used by at least one component (e.g., the processor 512) of the control module 510. The variety of data may include, for example, software, sensor data, input data or output data for instructions related thereto. The memory 514 may include a volatile memory or a non-volatile memory (e.g., random-access memory (RAM), dynamic RAM (DRAM), or static RAM (SRAM)).

The communication module 516 may support establishing a direct (e.g., wired) communication channel or a wireless communication channel between the control module 510 and another component of the wearable device 100 or an external electronic device (e.g., the electronic device 210 or the other wearable device 220 of FIG. 2) and performing communication via the established communication channel. The communication module 516 may include a communication circuit configured to perform a communication function. For example, the communication module 516 may receive a control signal from an electronic device (e.g., the electronic device 210) and transmit the sensor data obtained by the sensor module 520 to the electronic device. According to an embodiment, the communication module 516 may include one or more CPs (not shown) that are operable independently from the processor 512 and that support direct (e.g., wired) communication or wireless communication. According to an embodiment, the communication module 516 may include a wireless communication module (e.g., a cellular communication module, a short-range wireless communication module, or a global navigation satellite system (GNSS) communication module), and/or a wired communication module. A corresponding one of these communication modules may communicate with another component of the wearable device 100 and/or an external electronic device via a short-range communication network, such as Bluetooth™, Wi-Fi, or infrared data association (IrDA)), or a long-range communication network, such as a legacy cellular network, a fifth-generation (5G) network, a next-generation communication network, the Internet, or a computer network (e.g., a local area network (LAN) or a wide-area network (WAN)).

In an embodiment, the control systems 500 and 500-1 may further include a haptic module (not shown). The haptic module may provide haptic feedback to the user under the control of the processor 512. The haptic module may convert an electrical signal into a mechanical stimulus (e.g., a vibration or a movement) or an electrical stimulus, which may be recognized by the user via their tactile sensation or kinesthetic sensation. The haptic module may include a motor, a piezoelectric element, or an electrical stimulation device. In an embodiment, the haptic module may be positioned in at least one of a base body (e.g., the base body 80), the first thigh-fastening portion 2, or the second thigh-fastening portion 1.

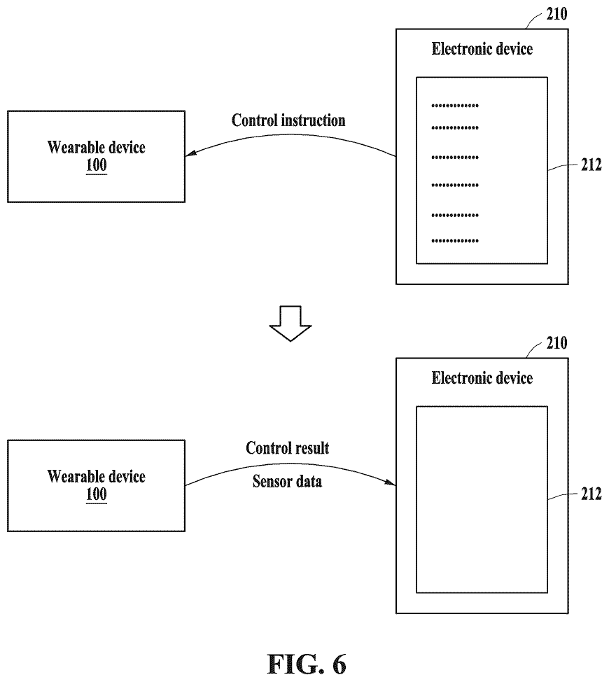

FIG. 6 is a diagram illustrating an interaction between a wearable device and an electronic device, according to an embodiment.

Referring to FIG. 6, the wearable device 100 may communicate with the electronic device 210. For example, the electronic device 210 may be a user terminal of a user using the wearable device 100 or a controller device dedicated for the wearable device 100. In an embodiment, the wearable device 100 and the electronic device 210 may be connected to each other through short-range wireless communication (e.g., Bluetooth communication or Wi-Fi communication).

In an embodiment, the electronic device 210 may check a state of the wearable device 100 or execute an application to control or operate the wearable device 100. A screen of a user interface (UI) may be displayed to control an operation of the wearable device 100 or determine an operation mode of the wearable device 100 on a display 212 of the electronic device 210 through the execution of the application. The UI may be, for example, a GUI.

In an embodiment, the user may input an instruction for controlling the operation of the wearable device 100 (e.g., an execution instruction to a walking assistance mode, an exercise assistance mode, or a physical ability measurement mode) or change settings of the wearable device 100 through a GUI screen on the display 212 of the electronic device 210. The electronic device 210 may generate a control instruction (or control signal) corresponding to an operation control instruction or a setting change instruction input by the user and transmit the generated control instruction to the wearable device 100. The wearable device 100 may operate according to the received control instruction and transmit, to the electronic device 210, a control result according to the control instruction and/or sensor data measured by the sensor module of the wearable device 100. The electronic device 210 may provide the user with result information (e.g., walking ability information, exercise ability information, or exercise posture evaluation information) derived by analyzing the control result and/or the sensor data through the GUI screen.

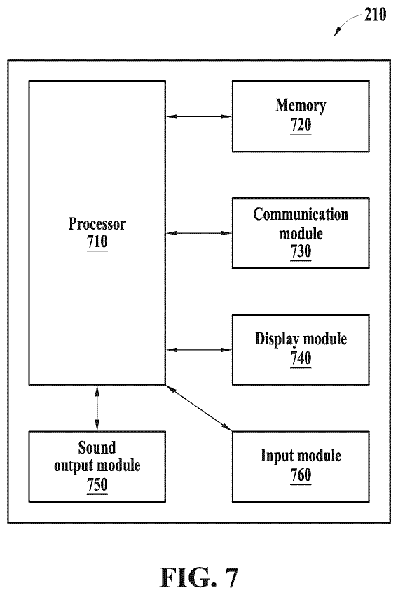

FIG. 7 is a diagram illustrating a configuration of an electronic device, according to an embodiment.

Referring to FIG. 7, the electronic device 210 may include a processor 710, a memory 720, a communication module 730, a display module 740, a sound output module 750, and an input module 760. In an embodiment, at least one (e.g., the sound output module 750) of the above components may be omitted from the electronic device 210, or one or more other components (e.g., a sensor module and a battery) may be added thereto.

The processor 710 may control at least one other component (e.g., a hardware or software component) of the electronic device 210 and may perform a variety of data processing or computation. According to an embodiment, as at least a part of data processing or computation, the processor 710 may store instructions or data received from another component (e.g., the communication module 730) in the memory 720, process the instructions or data stored in the memory 720, and store result data in the memory 720.

In an embodiment, the processor 710 may include a main processor (e.g., a CPU or an AP) or an auxiliary processor (e.g., a GPU, an NPU, an ISP, a sensor hub processor, or a CP) that is operable independently from or in conjunction with the main processor.

The memory 720 may store a variety of data used by at least one component (e.g., the processor 710 or the communication module 730) of the electronic device 210. The data may include, for example, a program (e.g., an application) and input data or output data for instructions related thereto. The memory 720 may include at least one instruction that is executable by the processor 710. The memory 720 may include a volatile memory or a non-volatile memory. The memory 720 may include one or more storage media storing instructions executable by the processor 710.

The communication module 730 may support establishing a direct (e.g., wired) communication channel or a wireless communication channel between the electronic device 210 and another electronic device (e.g., the wearable device 100, the other wearable device 220, or the server 230) and performing communication via the established communication channel. The communication module 730 may include a communication circuit configured to perform a communication function. The communication module 730 may include one or more CPs that are operable independently from the processor 710 (e.g., an AP) and that support direct (e.g., wired) communication or wireless communication. According to an embodiment, the communication module 730 may include a wireless communication module configured to perform wireless communication (e.g., a Bluetooth communication module, a cellular communication module, a Wi-Fi communication module, or a GNSS communication module) or a wired communication module (e.g., a LAN communication module or a power line communication (PLC) module). For example, the communication module 730 may transmit a control instruction to the wearable device 100 and receive, from the wearable device 100, at least one of sensor data including body motion information of the user who is wearing the wearable device 100, state data of the wearable device 100, or control result data corresponding to the control instruction.

The display module 740 may visually provide information to the outside (e.g., the user) of the electronic device 210. The display module 740 may include, for example, a liquid-crystal display (LCD) or an organic light-emitting diode (OLED) display, a hologram device, or a projector device. The display module 740 may further include a control circuit configured to control the driving of a display. In an embodiment, the display module 740 may further include a touch sensor adapted to sense a touch or a pressure sensor adapted to measure the intensity of force occurring by the touch.

The sound output module 750 may output a sound signal to the outside of the electronic device 210. The sound output module 750 may include a speaker configured to play back a guiding sound signal (e.g., an operation start sound or an operation error alarm), music content, or a guiding voice, based on the state of the wearable device 100. When it is determined that the wearable device 100 is not properly worn on the body of the user, the sound output module 750 may output a guiding voice for informing the user is wearing the wearable device 100 abnormally or for guiding the user to wear the wearable device 100 normally. The sound output module 750 may output, for example, a guiding voice corresponding to exercise evaluation information or exercise result information obtained by evaluating an exercise of the user.

The input module 760 may receive, from the outside (e.g., the user) of the electronic device 210, instructions or data to be used by a component (e.g., the processor 710) of the electronic device 210. The input module 760 may include an input component circuit and receive a user input. The input module 760 may include, for example, a key (e.g., a button) or a touch screen.

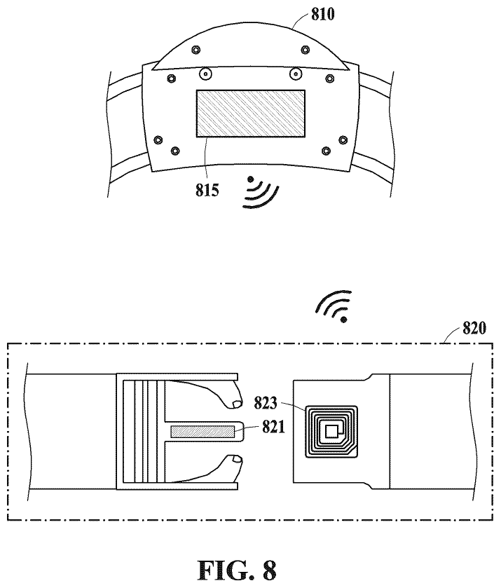

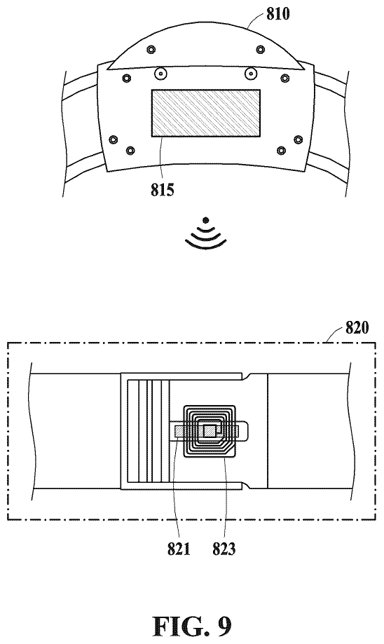

FIGS. 8 and 9 are diagrams illustrating a wearing detection system of a wearable device, according to an embodiment.

A wearing detection system of a wearable device (e.g., the wearable device 100 of FIG. 1) may include a base body 810 (e.g., the base body 80 of FIG. 4) and a wearing portion 820 of the wearable device. The base body 810 may include an RFID reader 815. The wearing portion 820 may represent a waist-wearing portion surrounding at least a portion of the lumber region of a user or a thigh-wearing portion surrounding at least a portion of the thigh of the user. The wearing portion 820 may represent the waist-fastening portion 60 or the thigh-fastening portions 1 and 2 of FIG. 3. The wearing portion 820 may include a first engaging portion and a second engaging portion that may be engaged with or disengaged from the first engaging portion. The structure and shape of the first engaging portion and the second engaging portion are not limited to what is shown in the drawings. The first engaging portion may include an RFID tag 823. The RFID tag 823 may be embedded inside the first engaging portion in the form of a tag or may be attached inside and/or outside the first engaging portion in the form of a sticker. The form of the RFID tag 823 is not limited to the described embodiment. The second engaging portion may include a material 821 interrupting the generation of induced current of the RFID tag 823. For example, the material 821 may include a magnet or other metal materials that may interrupt the generation of the induced current.

An integrated circuit (IC) chip of the RFID tag 823 may be operated by the induced current. For example, the RFID reader 815 may generate a magnetic field for electromagnetic induction. The induced current may be generated in the RFID tag 823 by the magnetic field generated by the RFID reader 815.

Referring to FIG. 8, when the wearing state of the wearable device is an insecure state (e.g., when the first engaging portion is not engaged with the second engaging portion), the material 821 of the second engaging portion does not affect the generation of the induced current of the RFID tag 823 of the first engaging portion, so wireless communication between the RFID reader 815 and the RFID tag 823 may be performed based on the induced current generated in the RFID tag 823.

Referring to FIG. 9, when the wearing state of the wearable device is a secure state, the material 821 and the RFID tag 823 may become close to each other as the first engaging portion is engaged with the second engaging portion, which may affect the generation of the induced current of the RFID tag 823 or may interrupt the generation of the induced current. When the induced current is not generated in the RFID tag 823, communication between the RFID reader 815 and the RFID tag 823 may not be performed.

According to an embodiment, the RFID tag 823 may be of a passive type that is operated by the induced current that is induced by a magnetic field of the RFID reader 815 without a direct power supply.

According to an embodiment, the RFID tag 823 may be of an active type that requires a power source.

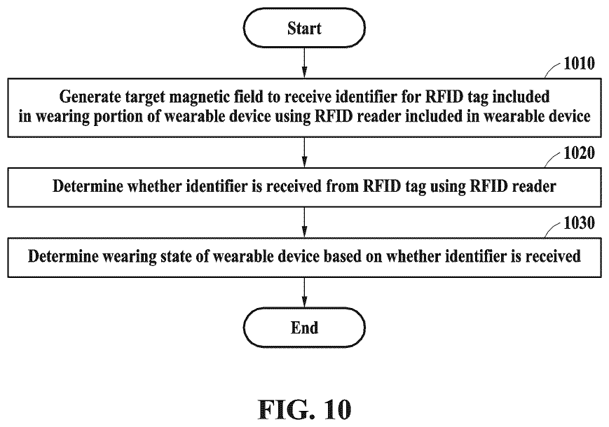

FIG. 10 is a flowchart of a method of detecting the wearing of a wearable device, according to an embodiment.

Operations 1010 to 1030 may be performed by a wearable device (e.g., the wearable device 100 of FIG. 1).

When a user performs an exercise program using the wearable device, the resistance force or assistance force of the wearable device may not be provided appropriately to the user when the wearing state of the wearable device is an insecure state. To appropriately provide the resistance force or assistance force of the wearable device to the user, it may be necessary to detect that the wearing state of the wearable device is a secure state at the time point when the exercise program is started and while the exercise program is being performed.

When the wearable device starts an exercise program selected by the user (e.g., through the electronic device 210 of FIG. 2), the wearable device may perform operations 1010 to 1030 after zeroing sensors (e.g., the angle sensor 125 and the IMU 135 of FIG. 1) provided in the wearable device.

According to an embodiment, the wearable device may perform operations 1010 to 1030 at a preset time interval while the exercise program is being performed.

In operation 1010, the wearable device may generate a target magnetic field to receive an identifier for an RFID tag (e.g., the RFID tag 823 of FIG. 8) included in a wearing portion (e.g., the wearing portion 820 of FIG. 8) of the wearable device using an RFID reader (e.g., the RFID reader 815 of FIG. 8) included in the wearable device. The identifier for the RFID tag may represent identification information stored in the RFID tag to identify the wearing portion including the RFID tag. For example, induced current may be generated in the RFID tag by the target magnetic field.

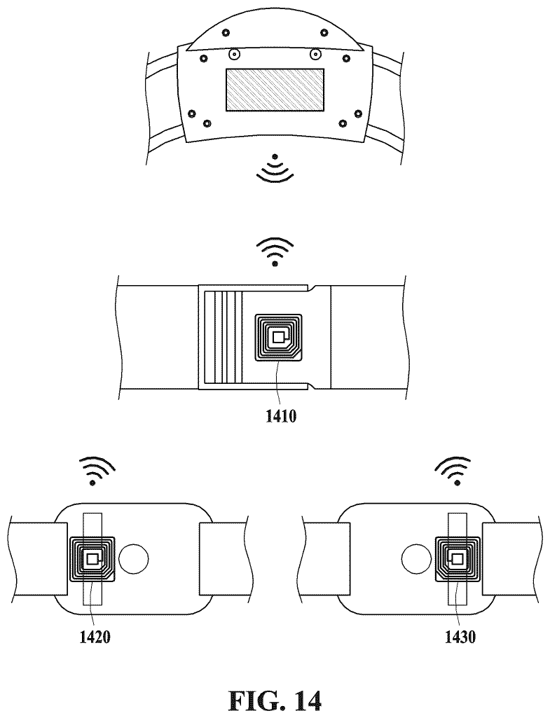

The wearable device may include a plurality of wearing portions including each sub-RFID tag. Each sub-RFID tag (e.g., a first sub-RFID tag, a second sub-RFID tag, etc.) may store a sub-identifier (e.g., a first sub-identifier, a second sub-identifier, etc.). The sub-identifier for each sub-RFID tag may represent identification information stored in each sub-RFID tag to identify each wearing portion including each sub-RFID tag. The sub-RFID tag is described in detail below with reference to FIG. 14.

In operation 1020, the wearable device may determine whether the identifier is received from the RFID tag using the RFID reader. The RFID tag may transmit the identifier for the RFID tag to the RFID reader when the induced current is effectively generated in the RFID tag by the target magnetic field.

When the identifier for the RFID tag is received from the RFID reader, the wearable device may determine that a first engaging portion and a second engaging portion of the wearing portion including the corresponding RFID tag are not engaged with or disengaged from each other. When the identifier for the RFID tag is not received from the RFID reader, the wearable device may determine that the first engaging portion and the second engaging portion of the wearing portion, which include the RFID tag corresponding to the identifier that is not received, are engaged with each other.

According to an embodiment, the wearable device may determine that the identifier is not received when information received by the RFID reader does not correspond to a reference identifier that is preset for the wearing portion or the RFID tag. The wearable device may determine that the identifier is received when the information received by the RFID reader corresponds to the reference identifier that is preset for the wearing portion or the RFID tag.

In operation 1030, the wearable device may determine the wearing state of the wearable device based on whether the identifier is received. For example, the wearable device may determine the wearing state of the wearable device to be an insecure state when the identifier is received. For example, the wearable device may determine the wearing state of the wearable device to be a secure state when the identifier is not received.

When the engagement of the first engaging portion with the second engaging portion is temporarily loosened or slightly loosened, weak induced current may be generated in the RFID tag, and the identifier may be transmitted to the RFID by the generated induced current. The wearable device may determine the wearing state of the wearable device by comparing the reception sensitivity to a signal of the identifier received by the RFID reader with a predetermined threshold.

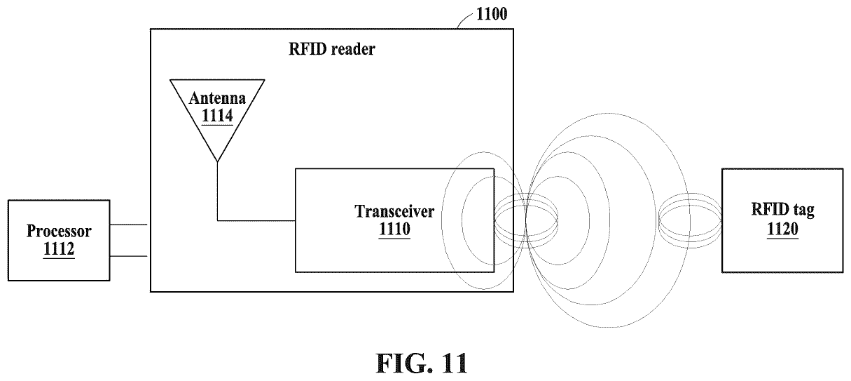

FIG. 11 is a diagram illustrating RFID communication of a wearable device, according to an embodiment.

An RFID reader 1100 (e.g., the RFID reader 815 of FIG. 8) may include a transceiver 1110 and an antenna 1114. The transceiver 1110 may represent an RFID transceiver.

A processor 1112 of a wearable device (e.g., the wearable device 100 FIG. 1) may generate a magnetic field by operating the transceiver 1110. The magnetic field may be induced to an RFID tag 1120 by the generated magnetic field by the transceiver 1110. Induced current may be generated in the RFID tag 1120 by the induced magnetic field. For example, an IC chip of the RFID tag 1120 may be operated by the induced current.

Information stored in the IC chip of the RFID tag 1120 may be signaled and be transmitted from an antenna of the RFID tag 1120 to the antenna 1114 of the RFID reader 1100. The transceiver 1110 may receive the information transmitted from the RFID tag 1120 based on the induced current of the RFID tag 1120. The transceiver 1110 may decrypt and transmit the received information to the processor 1112.

The processor 1112 may determine whether the received information is an identifier for the RFID tag 1120 or may include an identifier. For example, the processor 1112 may determine that the identifier is not received when the received information does not correspond to a reference identifier that is preset for a wearing portion (e.g., the wearing portion 820 of FIG. 8) or the RFID tag 1120. For example, the processor 1112 may determine that the identifier is received when the received information corresponds to the reference identifier that is preset for the wearing portion or the RFID tag 1120.

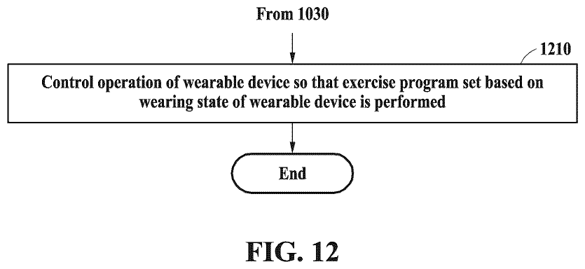

FIG. 12 is a flowchart of a method of controlling an operation of a wearable device, according to an embodiment.

According to an embodiment, operation 1210 may be performed after operation 1030 of FIG. 10. Operation 1210 may be performed by a wearable device (e.g., the wearable device 100 of FIG. 1).

In operation 1210, the wearable device may control the operation of the wearable device so that an exercise program set based on the wearing state of the wearable device is performed.

The wearable device may control the operation of the wearable device so that the set exercise program is performed when the wearing state of the wearable device is a secure state. The wearable device may control the wearable device so that the exercise program is not performed when the wearing state of the wearable device is an insecure state. For example, when the wearing state of the wearable device is an insecure state, the wearable device may control the wearable device to maintain a freestyle mode that does not provide the resistance force and assistance force to a user.

The wearable device may control the operation of the wearable device to provide the user with an exercise program for achieving an exercise goal in various exercise environments that the user desires. The exercise goal of the user may be preset and may include, for example, walking ability improvement, gait posture improvement, cardiovascular health improvement, and physical strength improvement. Under these exercise goals, the user may designate (e.g., through the electronic device 210 of FIG. 2) a target exercise section and a target exercise time as exercise environments before performing an exercise.

The exercise program may relate to a method of providing the resistance force and assistance force provided to the user who is wearing the wearable device in a set exercise environment. For example, the exercise program may provide the user with the same resistance force and assistance force in the entire exercise time. In another example, the exercise program may divide the entire exercise time into a plurality of sections and provide different pieces of resistance force and assistance force to the user in the plurality of sections. For example, the output timing of the resistance force and assistance force output through the exercise program may vary depending on the target exercise time and the exercise goal.

To achieve the exercise purpose of the user, an electronic device and/or a server (e.g., the server 230 of FIG. 2) may recommend an exercise program that is suitable for the user. The electronic device and/or the server may store and manage the exercise program performed by the user and the result of performing the exercise program.

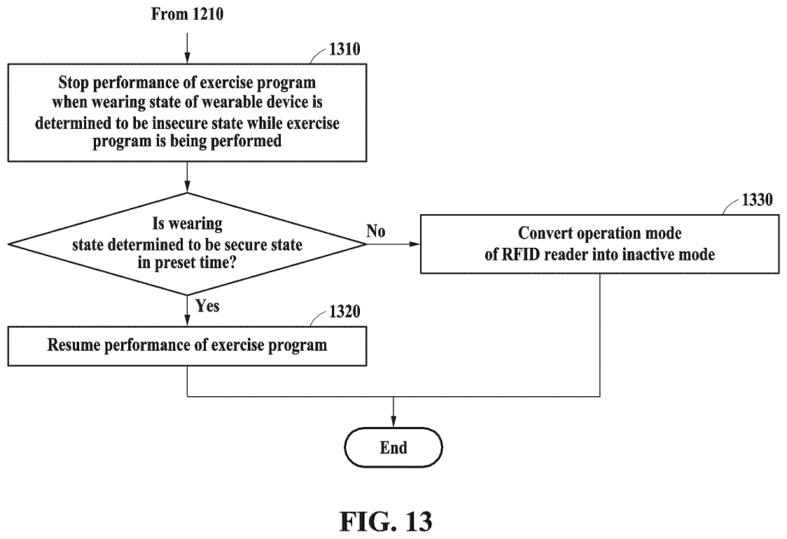

FIG. 13 is a flowchart of a method of controlling an operation of a wearable device, according to an embodiment.

According to an embodiment, operation 1310 may be performed after operation 1210 of FIG. 12. Operations 1310 to 1330 may be performed by a wearable device (e.g., the wearable device 100 of FIG. 1).

For example, the wearable device may generate a target magnetic field to receive an identifier for an RFID tag (e.g., the RFID tag 823 of FIG. 8) at a preset time interval while an exercise program is being performed, using an RFID reader (e.g., the RFID reader 815 of FIG. 8), determine whether the identifier is received from the RFID reader, and determine the wearing state of the wearable device based on whether the identifier is received. The description of operations 1010 to 1030 provided above with reference to FIG. 10 may be applied identically or similarly to the method of determining the wearing state of the wearable device, which is performed while the exercise program is being performed.

In operation 1310, the wearable device may stop the performance of the exercise program when the wearing state of the wearable device is determined to be an insecure state while the exercise program is being performed. For example, the wearable device may stop providing the resistance force and assistance force when the wearing state of the wearable device is determined to be an insecure state while the exercise program is being performed.

To prevent or reduce a chance of the wearable device from providing unsuitable assistance force or resistance force to the user due to a sudden stop in the provision of the assistance force or resistance force, the wearable device may execute a preset program to stop the exercise program. For example, the wearable device may gradually reduce the assistance force or resistance force output together with a signal sound.

According to an embodiment, when the wearing state of the wearable device is determined to be a secure state in a preset time after the wearing state of the wearable device is determined to be an insecure state, in operation 1320, the wearable device may resume the performance of the exercise program.

The wearable device may resume the performance of the same exercise program as the stopped exercise program in operation 1310.

The wearable device may maintain a standby mode that is waiting for a user input to the exercise program by resuming the performance of the exercise program.

According to an embodiment, when the wearing state of the wearable device is not determined to be a secure state in a preset time after the wearing state of the wearable device is determined to be an insecure state, in operation 1330, the wearable device may convert an operation mode of the RFID reader into an inactive mode. In the inactive mode, the RFID reader may not generate a target magnetic field. The wearable device may maintain the operation mode of the RFID reader in the inactive mode until the exercise program selected by the user is restarted.

FIG. 14 is a diagram illustrating a wearing portion of a wearable device, according to an embodiment.

A wearable device (e.g., the wearable device 100 of FIG. 1) may include a plurality of wearing portions including each sub-RFID tag. A sub-identifier for each sub-RFID tag may represent identification information stored in each sub-RFID tag to identify each wearing portion including each sub-RFID tag. The wearable device may store a reference identifier that is preset for each wearing portion or sub-RFID tag. The sub-RFID tag and the sub-identifier may be the same as the RFID tag and the identifier described above with reference to FIG. 10, respectively, and may be referred for classification according to the case in which the number of wearing portions included in the wearable device is one wearing portion or a plurality of wearing portions.

Referring to FIG. 14, a first sub-RFID tag 1410 may be included in an engaging portion of a waist-wearing portion surrounding at least a portion of the lumbar region of a user. A second sub-tag 1420 and a third sub-tag 1430 may be included in an engaging portion of a thigh-wearing portion surrounding at least a portion of the thigh of the user.

The wearable device may determine the wearing state of the wearable device based on whether the identifier for each sub-RFID tag is received. When the wearable device includes the plurality of wearing portions including each sub-RFID tag, the wearable device may determine the wearing state of each of the plurality of wearing portions. The wearable device may determine that the reference identifier is not received when information received by the RFID reader does not correspond to the reference identifier that is preset for each wearing portion or sub-RFID tag. “Based on” as used herein covers based at least on.

For example, when the RFID reader does not receive a first sub-identifier for the first sub-RFID tag 1410 but receives a second sub-identifier for the second sub-RFID tag 1420 and a third sub-identifier for the third sub-RFID tag 1430, the wearable device may determine the wearing state of the waist-wearing portion to be a secure state and determine the wearing state of the thigh-wearing portion to be an insecure state. The wearable device or an electronic device (e.g., the electronic device 210 of FIG. 2) may guide the user to check the wearing state of the thigh-wearing portion by voice or text.

When the sub-identifier of the sub-RFID tag is received from at least one of the plurality of wearing portions, the wearable device may determine the wearing state of the wearable device to be an insecure state. When a sub-identifier of any sub-RFID tag is received, this may indicate that the wearing state of the wearing portion including the corresponding sub-RFID tag is an insecure state. Since the assistance force or resistance force according to an exercise program may be appropriately provided to the user only when the wearing state of all the plurality of wearing portions is a secure state, the wearable device may determine the wearing state of the wearable device to be a secure state only when no sub-identifier is received from the RFID reader.

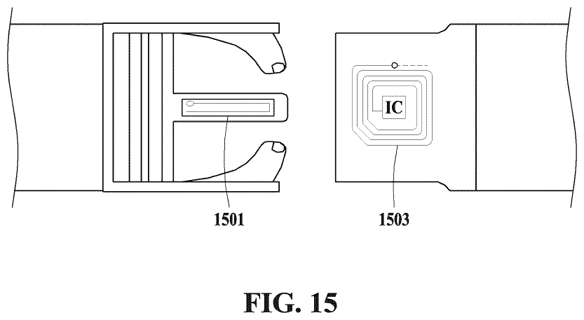

FIG. 15 is a diagram illustrating a configuration of a wearable device, according to an embodiment.

Referring to FIG. 15, a wearing portion of a wearable device (e.g., the wearable device 100 of FIG. 1) may include an RFID tag 1503 in a first engaging portion and an extension pattern 1501 in a second engaging portion. The extension pattern 1501 may represent an antenna extension pattern of the RFID tag 1503.

When the first engaging portion is not engaged with the second engaging portion, an RFID reader (e.g., the RFID reader 815 of FIG. 8) may not receive an identifier for the RFID tag 1503 from the RFID tag 1503 of which the resonant frequency of an antenna does not reach an RFID high-frequency (HF) band frequency (e.g., 13.56 megahertz (MHz)). When the RFID reader fails to receive the identifier for the RFID tag 1503, the wearable device may determine the wearing state of the wearing portion to be an insecure state.

When the first engaging portion is engaged with the second engaging portion, the extension pattern 1501 and the RFID tag 1503 are connected to each other and correspond to the RFID HF band frequency, so the RFID reader may receive the identifier for the RFID tag 1503 from the RFID tag 1503. For example, circuits of the RFID tag 1503 and the extension pattern 1501 may be connected to each other using a POGO pin. When the RFID reader receives the identifier for the RFID tag 1503, the wearable device may determine the wearing state of the wearing portion to be a secure state.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

Software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts.

Examples of non-transitory computer-readable media include magnetic media such as hard disks, floppy disks, and magnetic tape; optical media such as CD-ROM discs or DVDs; magneto-optical media such as floptical disks; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and equivalents to the claims are also within the scope of the following claims.

1. A method performed by a wearable device, the method comprising:
generating a target magnetic field to receive an identifier for a radio frequency identification (RFID) tag comprised in a wearing portion of the wearable device using at least an RFID reader comprised in the wearable device;
determining whether the identifier is received from the RFID tag using at least the RFID reader; and
determining a wearing state of the wearable device based on whether the identifier is received.

2. The method of claim 1, wherein a first engaging portion of the wearing portion comprises the RFID tag,
wherein a second engaging portion of the wearing portion, which is configured for being engaged with and/or disengaged from the first engaging portion, comprises a material interrupting generation of induced current of the RFID tag.

3. The method of claim 2, wherein generation of the induced current of the RFID tag by at least the target magnetic field is interrupted by the material when the first engaging portion is engaged with the second engaging portion.

4. The method of claim 2, further comprising:
receiving, using at least the RFID reader, the identifier, which is transmitted from the RFID tag based on the induced current of the RFID tag generated by the target magnetic field, when the first engaging portion is not engaged with the second engaging portion.

5. The method of claim 1, wherein the determining of whether the identifier is received from the RFID tag comprises determining that the identifier is not received when information received by the RFID reader does not correspond to a reference identifier that is preset for the wearing portion or the RFID tag.

6. The method of claim 1, wherein the determining of the wearing state of the wearable device based on whether the identifier is received comprises determining the wearing state of the wearable device to be an insecure state when the identifier is received.

7. The method of claim 1, wherein the determining of the wearing state of the wearable device based on whether the identifier is received comprises, when the wearable device comprises a plurality of wearing portions comprising each sub-RFID tag, determining a wearing state of each of the plurality of wearing portions.

8. The method of claim 7, wherein the determining of the wearing state of the wearable device based on whether the identifier is received comprises determining the wearing state of the wearable device to be an insecure state when a sub-identifier of a sub-RFID tag is received from at least one of the plurality of wearing portions.

9. The method of claim 1, wherein the determining of the wearing state of the wearable device based on whether the identifier is received comprises determining the wearing state of the wearable device to be a secure state when the identifier is not received.

10. The method of claim 1, further comprising:
controlling an operation of the wearable device so that an exercise program set based on the wearing state of the wearable device is performed.

11. The method of claim 10, further comprising:
stopping performance of the exercise program when the wearing state of the wearable device is determined to be an insecure state while the exercise program is being performed.

12. The method of claim 11, further comprising:
resuming the performance of the exercise program when the wearing state is determined to be a secure state in a preset time while the performance of the exercise program is stopped.

13. The method of claim 11, further comprising:
converting an operation mode of the RFID reader into an inactive mode when the wearing state is not determined to be a secure state in a preset time while the performance of the exercise program is stopped.

14. The method of claim 1, wherein the wearing portion of the wearable device comprises at least one of a waist-wearing portion configured for surrounding at least a portion of a lumbar region of a user or a thigh-wearing portion configured for surrounding at least a portion of a thigh of a user.

15. A wearable device comprising:
a wearing portion of the wearable device which comprises at least one of a waist-wearing portion configured for surrounding at least a portion of a lumbar region of a user or a thigh-wearing portion configured for surrounding at least a portion of a thigh of a user;
at least one processor comprising processing circuitry; and
memory comprising one or more storage media storing instructions that, when executed by the at least one processor individually or collectively, cause the wearable device to perform at least:
generating a target magnetic field to receive an identifier for a radio frequency identification (RFID) tag comprised in the wearing portion of the wearable device using an RFID reader comprised in the wearable device;
determining whether the identifier is received from the RFID tag using the RFID reader; and
determining a wearing state of the wearable device based on whether the identifier is received.

16. A wearable device comprising:
at least one processor comprising processing circuitry;
a radio frequency identification (RFID) reader;
a wearing portion of the wearable device which comprises an RFID tag and at least one of a waist-wearing portion configured for surrounding at least a portion of a lumbar region of a user or a thigh-wearing portion configured for surrounding at least a portion of a thigh of a user;
a motor driver circuit configured to be controlled by the at least one processor;
a motor electrically connected to the motor driver circuit; and
memory comprising one or more storage media storing instructions that, when executed by the at least one processor individually or collectively, cause the wearable device to perform:
generating a target magnetic field to receive an identifier for the RFID tag using the RFID reader;
determining whether the identifier is received from the RFID tag using the RFID reader; and
determining a wearing state of the wearable device based on whether the identifier is received.

17. The wearable device of claim 16, wherein a first engaging portion of the wearing portion comprises the RFID tag,
wherein a second engaging portion of the wearing portion, which is configured for being engaged with and/or disengaged from the first engaging portion, comprises a material interrupting generation of induced current of the RFID tag.

18. The wearable device of claim 17, wherein generation of the induced current of the RFID tag by at least the target magnetic field is interrupted by the material when the first engaging portion is engaged with the second engaging portion.

19. The wearable device of claim 17, wherein the instructions, when executed by the at least one processor individually or collectively, further cause the wearable device to perform:
receiving, using at least the RFID reader, the identifier, which is transmitted from the RFID tag based on the induced current of the RFID tag generated by the target magnetic field, when the first engaging portion is not engaged with the second engaging portion.

20. The wearable device of claim 16, wherein the determining of whether the identifier is received from the RFID tag comprises determining that the identifier is not received when information received by the RFID reader does not correspond to a reference identifier that is preset for the wearing portion or the RFID tag.
